(19) United States
(12) Patent Application Publication
(10) Pub. No.: US 2005/0246762 A1
(43) Pub. Date: Nov. 3, 2005

(54) Changing access permission based on usage of a computer resource

(75) Inventors: Janice Marie Girouard, Austin, TX (US); Emily Jane Ratliff, Austin, TX (US); Kent Edward Yoder, Austin, TX (US); Jerone B. Young, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/834,497

(22) Filed: Apr. 29, 2004

(51) Int. Cl. H04L 9/00

(52) U.S. Cl. 726/2

(57) ABSTRACT

Changing access permission based on usage of computer resources including maintaining records of a user's usage of computer resources in a security domain, the user having a scope of access permission for the computer resources; measuring the user's disuse of one or more of the computer resources in the security domain; and degrading the user's scope of access permission for the computer resources in dependence upon the user's disuse. Typical embodiments include receiving from a user a request for access to a requested computer resource, receiving from the user a request to upgrade the user's degraded scope of access permissions to grant access to the requested computer resource and upgrading, in dependence upon the user's request to upgrade the degraded scope of access permissions, the user's degraded scope of access permissions to grant access to the requested computer resource.

### BACKGROUND OF THF INVFNTTON

1. Field of the Invention

The field of the invention is data processing, or, more specifically, methods, systems, and products for changing access permission based on usage of a computer resource.

2. Description Of Related Art Least privilege is a fundamental security concept that states that computer system security is stronger when users are granted only those permissions to access computer resources needed to do a job. Least privilege is an ideal that is often not achieved due to the complexity of determining the least privilege required for each user. Password and account expiration after a period of disuse are ways of achieving a kind of least privilege, but they are heavy handed. There is an ongoing need for improvements in systems support for least privilege administration.

### SUMMARY OF THE INVENTION

Method, systems, and products are disclosed for changing access permission based on usage of computer resources that include maintaining records of a user's usage of computer resources in a security domain; measuring the user's disuse of one or more of the computer resources in the security domain; and degrading the user's scope of access permission for the computer resources in dependence upon the user's disuse. In such embodiments, the user typically has a scope of access permission for the computer resources.

Typical embodiments include receiving from a user a request for access to a requested computer resource, the user having a degraded scope of access permissions that exclude access to the requested computer resource, denying access to the requested computer resource in dependence upon the user's degraded scope of access permissions that exclude access to the requested computer resource, receiving from the user a request to upgrade the user's degraded scope of access permissions to grant access to the requested computer resource and upgrading, in dependence upon the user's request to upgrade the degraded scope of access permissions, the user's degraded scope of access permissions to grant access to the requested computer resource. Typical embodiments include receiving from the user a request for access to a requested computer resource, the user having a degraded scope of access permissions that exclude access to the requested computer resource, and measuring the user's current disuse of the requested computer resource, and upgrading, in dependence upon a previous scope of access permissions for the requested computer resource and upon the current measure of disuse by the user of the requested computer resource, the user's degraded scope of access permissions to grant access to the requested computer resource.

In typical embodiments, at least one computer resource has access permissions for a multiplicity of users. In such embodiments, each access permission for a user may be expressed in an ACE in an ACL for the at least one computer resource, and a plurality of individual ACEs in the ACL identify one or more sets of users having matching access permissions. Such embodiments typically include creating a new group ACE for each set of users having matching access permissions, recording for each user in each set of users having matching access permissions a new group membership, and deleting from the ACL the individual ACEs that identify one more sets of users having matching access permissions.

In typical embodiments, maintaining records of a user's usage of computer resources includes creating a user access history for each computer resource. In such embodiments, the user access history includes user identification, computer resource identification, and a timestamp identifying the date and time of a user's accessing a computer resource associated with the user access history. In typical embodiments, measuring disuse of the one or more computer resources includes comparing a timestamp in a user access history with a predetermined threshold.

In some embodiments, degrading the user's scope of access permission for the computer resources in dependence upon the disuse includes degrading the user's scope of access permission for the computer resources according to permission degradation rules. Such embodiments may also include generating a disuse profile, degrading the user's scope of access permission for the computer resources in dependence upon the disuse includes an authorized user's degrading the user's scope of access permission for the computer resources in dependence upon the disuse profile.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a database diagram illustrating exemplary data structures useful according to various embodiments of the present invention.

FIG. 2 sets forth a block diagram of automated computing machinery.

FIG. 3 sets forth a flow chart illustrating an exemplary method of changing access permission based on usage of a computer resource.

FIG. 4 sets forth a flow chart illustrating an exemplary method of measuring a user's disuse of one or more of the computer resources in the security domain.

FIG. 5 sets forth a flow chart illustrating an exemplary method for changing access permission to access a computer resource in dependence upon usage.

FIG. 6 sets forth a flow chart illustrating an exemplary method for changing access permission based on usage of a computer resource that includes upgrading previously degraded permissions for a user.

FIG. 7 sets forth a flow chart illustrating an exemplary method of changing access permission based on usage of computer resources that effectively collapses a number of individual ACEs into a smaller number of group ACEs.

### DETAILED DESCRIPTION OF EXEMPLARY EMOBIDMENTS

### Introduction

The present invention is described to a large extent in this specification in terms of methods for changing access permission based on usage of a computer resource. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Changing Access Permission Based on Usage of a Computer Resource

Methods, systems, and products are disclosed for changing access permission based on usage of a computer resource that operate generally by maintaining records of a user's usage of computer resources in a security domain, measuring a user's disuse of one or more of the computer resources in the security domain, and degrading the user's scope of access permission for the computer resources in dependence upon the user's disuse. In the context of the present invention, a ‘user’ is a computational process that accesses computer resources. A user may optionally represent a person, but that is not a limitation of the invention. Examples of users include terminal processes and console processes associated with persons operating computer terminals or consoles, security daemons associated with no particular person, terminal, or console, as well as software agents, server processes, and others as will occur to those of skill in the art. In this specification, therefore, the terms “user identification” or “userID” include process identifications as well as user logon identifications.

In this specification, the term “resource” or “computer resource” means any information or physical item access to which is controlled by methods, systems, or products according to the present invention. The most common kind of resource is a file, but resources include dynamically-generated query results, the output of Common Gateway Interface (“CGI”) scripts, dynamic server pages, documents available in several languages, as well as physical objects such as garage doors, briefcases, and so on. Resources often comprise information in a form capable of being identified by a Uniform Resource Identifier (“URI”) or Uniform Resource Locator (“URL”). It is useful therefore to consider a resource as similar to a file, but more general in nature. Files as resources include web pages, graphic image files, video clip files, audio clip files, and so on. As a practical matter, many resources are either files or dynamic output from server side functionality. Server side functionality includes CGI programs, Java servlets, Active Server Pages, Java Server Pages, and so on.

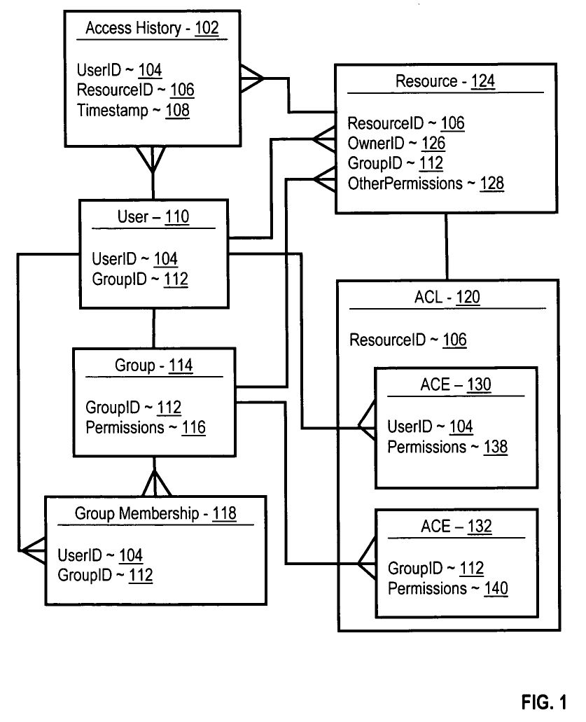

FIG. 1 sets forth a diagram illustrating exemplary data structures and relations among data structures useful according to various embodiments of the present invention to maintain records of a user's usage of computer resources in a security domain, measure a user's disuse of one or more of the computer resources in the security domain, and degrade the user's scope of access permission for the computer resources in dependence upon the user's disuse. The data structures of FIG. 1 include an access history table (102) each record of which represents an access of a computer resource by a user. Each access history record (102) includes a user identification (104) identifying the user who accessed the resource, a resource identification (106) that identifies the resource accessed and functions as a foreign key into resource table (124), and a timestamp (108) identifying the date and time when the user accessed the resource. The resource identification may be implemented as a computer resource's filename, a pathname, a URL measuring a resource on a file system on a host computer on a network, and in other ways as will occur to those of skill in the art.

The exemplary data structures of FIG. 1 include a data structure (124) representing a computer resource. That is, each record in resource table (124) represents a computer resource. Each resource record includes a resource identification field (106), an owner identification field (126) that functions as a foreign key into user table (110), a group identification field (112) that functions as a foreign key into group table (114), and an other permission field (128) for storing permissions for users who are neither the owner of a resource nor a member of a group with permission to access the resource. The exemplary data structure (124) representing a computer resource is only an example for explanation. The exact structure of a data structure representing a computer resource accessible through a host computer depends on the operating system on the host computer. In Microsoft's MSDOS™, for example, data structures representing computer resources are implemented as entries in a file access table or “FAT.” In many forms of Unix, data structures representing computer resources are implemented as “inodes.” And in Windows NT™, data structures representing computer resources are implemented as records in an array stored in a special file called the Master File Table (“MFT”).

The exemplary data structures of FIG. 1 include an access control list (“ACL”) (120). An ACL is a list of access control entries (“ACEs”) (130, 132). Each ACE defines a set of permissions for a user (138) or for a group of users (140). Compared to the owner/group/other permissions mentioned above, an ACL (120) provides more precise control over which users may access a computer resource and what access rights each user may have. Examples of access permissions that may be granted or denied in each ACE include:
permission to change an ACL
permission to delete a file, directory, or other computer resource
permission to create a file, directory, or other computer resource
permission to read a file, directory, or other computer resource
permission to write to a file, directory, other computer resource
permission to search a directory, execute a file, or operate another computer resource

The exemplary data structures of FIG. 1 include a user table (110). Each record in the user table represents a user, a person or computational process, that may be authorized to access computer resources. Each record in the user table (110) includes a user identification field (104) and a group identification field (112) that functions as a foreign key into a group table (114) and identifies a group membership for a user in systems supporting only one group membership per user.

The exemplary data structures of FIG. 1 include a group table (114) each record of which represents a group of users having the same permissions to access a computer resource. Each group record includes a group identification field (112) and an optional group permissions field (116) measuring the permissions granted for all members of the group to access a computer resource. Group permissions field (116) is optional in the sense that group permissions in systems using ACLs alternatively may be expressed in permissions structures (140) in group ACEs (132).

The exemplary data structures of FIG. 1 include a group membership table (118) that is useful in systems that allow multiple group memberships for each user. Each record of the group member ship table (118) represents a user's membership in a group. Each group membership record includes a user identification field (104) that functions as a foreign key to the user records (110), implementing a one-to-many relationship between the users (110) and group memberships (118). Each group membership record includes a group identification field (112) that functions as a foreign key to the group records (114), implementing a one-to-many relationship between groups (114) and group memberships (118). The one-many-relationship between users (110) and group memberships (118) and the one-to-many relationship between groups (114) and group memberships (118), taken together, implement a many-to-many relationship between users (110) and groups (114). That is, in such a system, each user may be a member of many groups, and each group may have many member users.

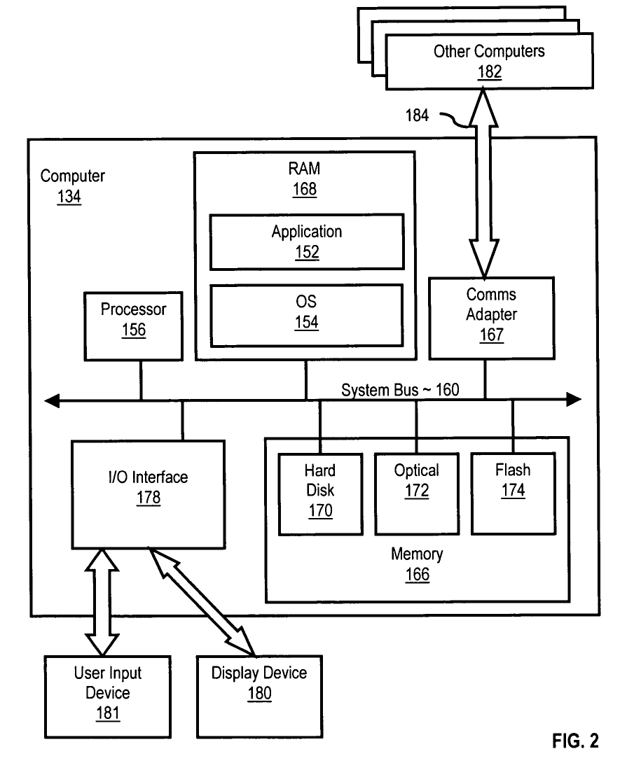

The term “computer,” in this specification, refers to any automated computing machinery. The term “computer” therefore includes not only general purpose computers such as laptops, personal computer, minicomputers, and mainframes, but also devices such as personal digital assistants (“PDAs), network enabled handheld devices, internet-enabled mobile telephones, and so on. For further explanation, FIG. 2 sets forth a block diagram of automated computing machinery comprising a computer (134), such as a local host, remote host, or server, useful in systems for changing access permission based on usage of a computer resource according to embodiments of the present invention. The computer (134) of FIG. 2 includes at least one computer processor (156) or ‘CPU’ as well as random access memory (168) (“RAM”). Stored in RAM (168) is an application program (152). Application programs useful in accordance with various embodiments of the present invention include browsers, word processors, spreadsheets, database management systems, email clients, and so on, as will occur to those of skill in the art.

Also stored in RAM (168) is an operating system (154). Operating systems useful in computers according to embodiments of the present invention include Unix, Linux, Microsoft NT™, and many others as will occur to those of skill in the art. Computer program instructions for degrading access permission based on disuse of a computer resource according to embodiments of the present invention may be implemented at least to some extent in application software (152). It is operating systems, however, that include many of the computer software that governs and administers access to computer resources, and operating systems will often include many of the computer program instructions needed for degrading access permission based on disuse of a computer resource according to embodiments of the present invention.

The computer (134) of FIG. 2 includes computer memory (166) coupled through a system bus (160) to the processor (156) and to other components of the computer. Computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer (134) of FIG. 2 includes communications adapter (167) implementing couplings for data communications (184) to other computers (182), servers or clients. Communications adapters implement the hardware level of connections for data communications through which local hosts and remote hosts or servers send data communications directly to one another and through networks. Examples of communications adapters include modems for wired dial-up connections, Ethernet (IEEE 802.3) adapters for wired LAN connections, and 802.11b adapters for wireless LAN connections.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

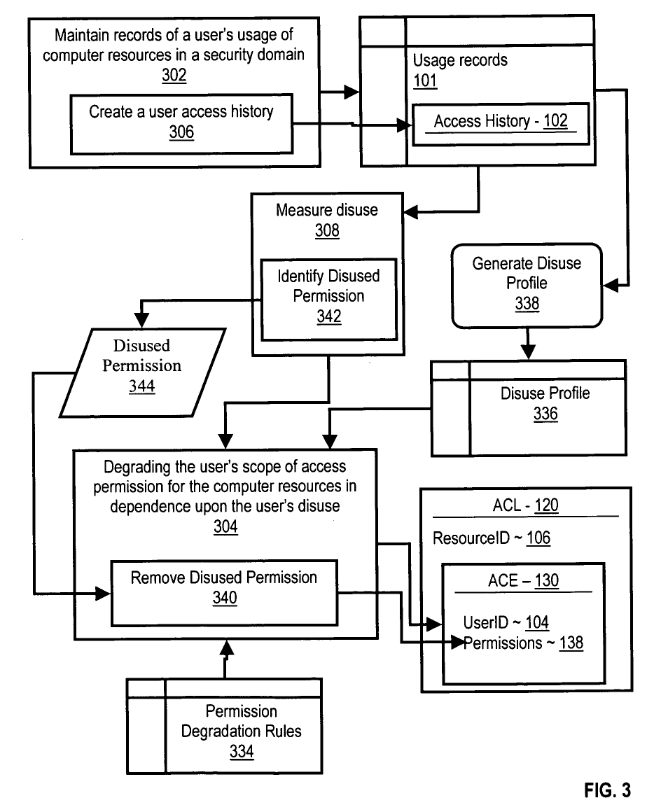

For further explanation, FIG. 3 sets forth a flow chart illustrating an exemplary method of changing access permission based on usage of a computer resource that includes maintaining (302) records of a user's usage of computer resources in a security domain, measuring (308) a user's disuse of one or more of the computer resources in the security domain, and degrading (304) the user's scope of access permission for the computer resources in dependence upon the user's disuse. In the method of FIG. 3, the user has a scope of access permission for the computer resources in the security domain. A security domain is a unit of security administration. A security domain may apply to the computer resources of a single computer, multiple computers connected in a network, to a subset of resources on a single computer, and otherwise as will occur to those of skill in the art. A user's scope of access permissions for the computer resources in a security domain includes the totality of all access permissions for the user for all the resources in the domain. In the method of FIG. 3, maintaining (302) records of a user's usage of computer resources in a security domain includes creating (306) a user access history (102) for each resource accessed by a user. In this example, the user access history (102) includes, as shown on FIG. 1, a user identification (104), a computer resource identification (106), and a timestamp (108) identifying the date and time of a user's accessing the computer resource.

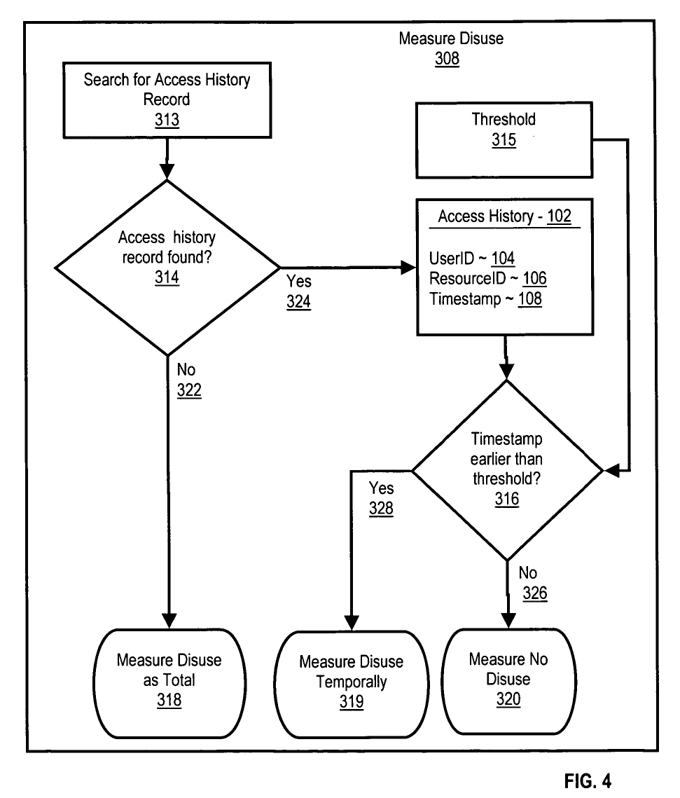

The method of FIG. 3 includes measuring (308) the user's disuse of one or more of the computer resources in the security domain. For further explanation, FIG. 4 sets forth a flow chart illustrating an exemplary method of measuring (308) a user's disuse of one or more of the computer resources in the security domain. In the method of FIG. 4, measuring (308) disuse of the computer resource is carried out by searching (313) for an access history record for the computer resource. If the search fails, no access history record is found (322), the method of FIG. 4 measures disuse as total (318). That is, in this example, the complete absence of any access history means that the user in question has never accessed the resource, and the user's disuse of the resource is represented as total by for example encoding the entire period of time from the resource's creation until the present. Alternatively, total disuse may be encoded for data processing in any fashion that will occur to those of skill in the art including, for example, simply leaving a disuse field null.

In the method of FIG. 4, if measuring (308) disuse of the computer resource by searching (313) for an access history record for the computer resource succeeds and an access history record is found (324), processing proceeds by comparing (316) a timestamp (316) in the access history record with a predetermined threshold (315). The predetermined threshold (315) is an expression of a period of time prior to the present the present time used to detect the existence of disuse. A predetermined threshold (315) may be defined for a resource, for a set of resources, or for all resources in a security domain.

The present time is the time read by a computational process from a system clock. The predetermined threshold (315) in this example is used with a timestamp (108) to detect the existence of disuse. If the period of time from the present to the timestamp is less than the predetermined threshold (326), no disuse has occurred at all, and in this circumstance, disuse is said to be measured as ‘no disuse’ (320). If the period of time from the present to the timestamp is greater than the predetermined threshold (328), in this example, disuse is measured temporally as the period of time from the present to the timestamp.

Again with reference to FIG. 3: The method of FIG. 3 includes degrading (304) the user's scope of access permission for the computer resources in dependence upon the user's disuse. Degrading (304) the user's scope of access permission for the computer resources in dependence upon the disuse is carried out in many embodiments according to permission degradation rules (334). Permission degradation rules are processing guidelines for degrading permissions in dependence upon varying degrees of disuse. For further explanation, three exemplary permission degradation rules are set forth below:
RULE 1:
If a temporal measure of a user's disuse of a resource is greater than one week
AND
the user's scope of access permission includes delete permission for the resource
THEN
degrade the user's scope of access permission to exclude delete permission for that resource
RULE 2:
If a temporal measure of a user's disuse of a resource is greater than one month
AND
the user's scope of access permission includes write permission for the resource
THEN
degrade the user's scope of access permission to exclude write permission for that resource
RULE 3:
If a temporal measure of a user's disuse of a resource is greater than two months
THEN
degrade the user's scope of access permission to exclude all access to that resource

The fact that three rules are used to exemplify permission degradation rules is not a limitation of the present invention. The use of any number of permission degradation rules is well within the scope of the present invention. These exemplary permission degradation rules illustrate that systems according to embodiments of the present invention advantageously may gracefully reduce a user's scope of access permissions in a security domain over time with precise granularity, resource-by-resource, thereby avoiding an abrupt termination of all access for a user to an entire system or domain.

For further explanation, FIG. 3 illustrates an additional alternative method for measuring (308) the user's disuse of one or more of the computer resources in the security domain and degrading (304) the user's scope of access permission. In this alternative example of FIG. 3, measuring (308) the user's disuse of one or more of the computer resources in the security domain is carried out by identifying (344), among permissions for the user, a disused access permission (344) for at least one of the computer resources. A disused access permission is an access permission within the user's scope of access permissions that the user either has not used at all or has not used with some threshold period of time. In this exemplary method according to FIG. 3, degrading (304) the user's scope of access permission for the computer resources in dependence upon the user's disuse is carried out by removing (340) the disused permission from the permissions for the user (138). The alternative method according to FIG. 3 advantageously provides a mechanism to remove only those specific permissions that are in relative or absolute disuse. That is, for example, a user having ‘read’ and ‘write’ permissions for a file who never uses the ‘write’ permission loses the ‘write’ permission but not the read permission.

The method of FIG. 3 includes the alternative process of generating (338) a disuse profile (336). In the example using a disuse profile, degrading (304) the user's scope of access permission for the computer resources in dependence upon the disuse may be carried out by an authorized user who degrades another user's scope of access permission for computer resources in dependence upon a disuse profile (336). A disuse profile may be generated as a report in electronic form or hard copy profiling disuse according to user identification and resource identification.

Disuse Profile
Domain Name: SomeSecurityDomain
As of: MMDDYY

| UserID | ResourceID | Disuse (days) |
|---|---|---|
| joe | someFile.doc | 40 |
| joe | someOtherFile.doc | 20 |
| joe | someCGIscript.cgi | 10 |
| mike | someFile.doc | Total |
| mike | someOtherFile.doc | 30 |
| mike | stillAnotherFile.pdf | 10 |
| mike | someJavaServerPage.jsp | 0 |

This exemplary disuse profile is sorted first by UserID and second by Disuse measured in days. Such a disuse profile advantageously allows a system administrator or other authorized users to degrade users' scopes of access permission for computer resources in a security domain in a graceful manner without necessarily abruptly excluding all access. In the method of FIG. 3, degrading (304) the user's permission to access the computer resource in dependence upon usage also includes altering permissions (138) expressed in an ACE (130) in an ACL (310) for a computer resource.

### Upgrading Permissions

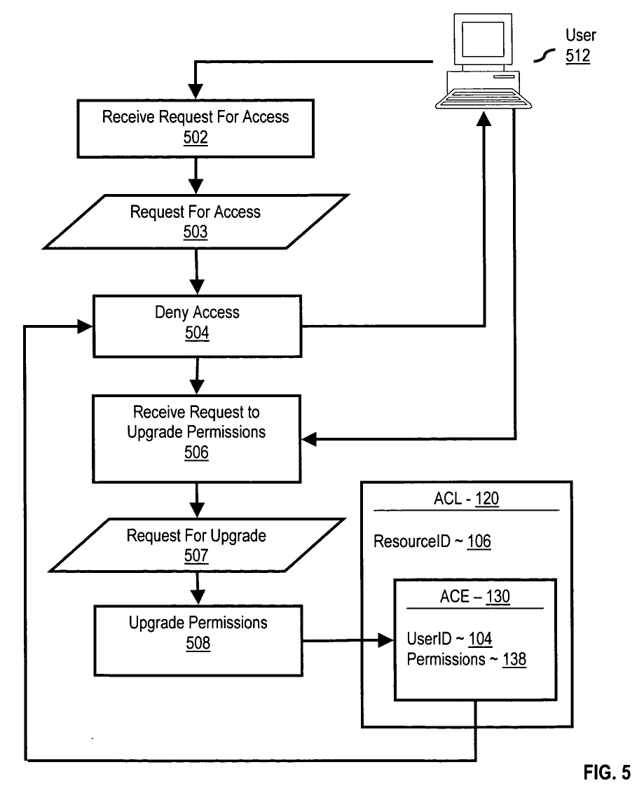

For still further explanation, FIG. 5 sets forth a flow chart illustrating a further exemplary method for changing access permission based on usage of a computer resource that includes upgrading previously degraded permissions for a user. More particularly, the method of FIG. 5 includes receiving (502) from a user (512) a request (503) for access to a requested computer resource. In the example of FIG. 5, the user (512) has a degraded scope of access permissions (138) that exclude access to the requested computer resource. Because the user (512) has a degraded scope of access permissions (138) that exclude access to the requested computer resource, the method of FIG. 5 includes denying (504) access to the requested computer resource.

The method of FIG. 5 includes receiving (506) from the user a request (507) to upgrade the user's degraded scope of access permissions (138) to grant access to the requested computer resource. That is, in this example, the system in denying access may notify the user, through a GUI dialog box, for example, of the user's degraded permissions and prompt the user for an indication whether the user would prefer to upgrade. A positive response from the user is receiving (506) from the user a request (507) to upgrade. The method of FIG. 5 includes upgrading (508), in dependence upon the user's request (507) to upgrade the degraded scope of access permissions, the user's degraded scope of access permissions (138) to grant access to the requested computer resource. Upgrading (508), in dependence upon the user's request (507) to upgrade the degraded scope of access permissions, the user's degraded scope of access permissions (138) to grant access to the requested computer resource may be carried out securely by, for example, synchronously notifying a system administrator or other user having authority to upgrade permissions. In such an example, synchronous notification means that the upgrade process blocks until an authorized user authorizes the upgrade and times out or fails if the authorized user does not authorize the upgrade. Synchronous notification may be implemented through an instant message service with presence detection, such as, for example, a Small Message Service (SMS”) messaging system that may possess a list of administrators presently available on-line to accept such synchronous notifications.

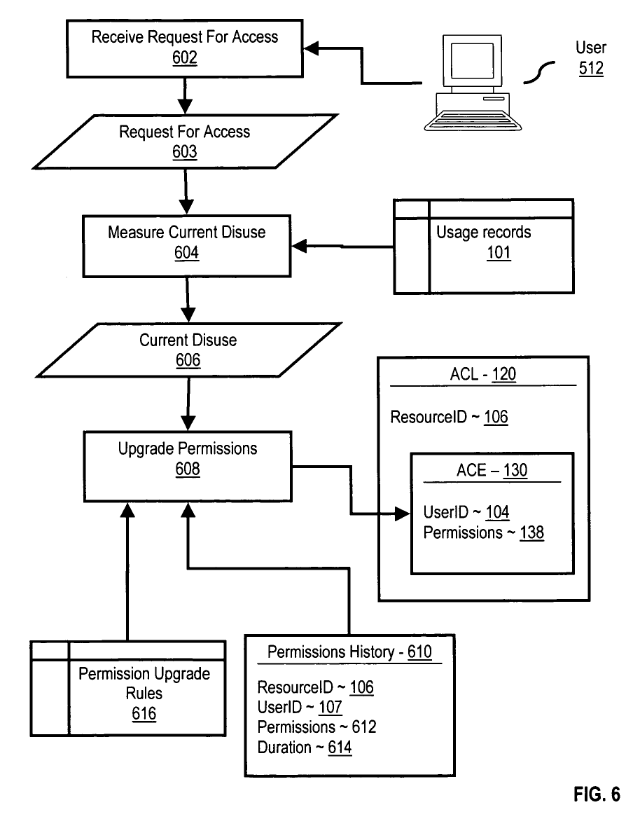

For even further explanation, FIG. 6 sets forth a flow chart illustrating a further exemplary method for changing access permission based on usage of a computer resource that includes upgrading previously degraded permissions for a user. More particularly, the method of FIG. 6 includes receiving (602) from the user (512) a request (603) for access to a requested computer resource. In the example of FIG. 6, the user (512) has a degraded scope of access permissions (138) that excludes access to the requested computer resource. The method of FIG. 6 also includes measuring (604) the user's current disuse (606) of the requested computer resource and upgrading (608), in dependence upon a previous scope of access permissions (610) for the requested computer resource and upon the current measure of disuse (606) by the user of the requested computer resource, the user's degraded scope of access permissions (138) to grant access to the requested computer resource. In the example of FIG. 6, a user's previous scope of access permissions (610) for the requested computer resource is maintained in a permissions history table (610) whose records include a resourceID (106), a userID (107), a set of previous permissions (612) for the user for the resource identified by the resourceID, and a duration (614).

The duration (614) represents the period of time that the previous permissions were valid for the user for the resource. A duration (614) may be implemented as a period of time, a number of days, weeks, months, years, or seconds. Alternatively, duration may be implemented as a start date and an end date defining between them a period during which a particular permissions were valid for a user for a resource. Alternatively, in a system where permissions history records may be sequenced according to an end date for permissions, duration may be implemented in data as an end date only, with duration for a particular set of permissions calculated as the difference between the end dates of two sequential permissions history records for a user for a resource. Duration may also be implemented in other ways as will occur to those of skill in the art, and all such ways are well within the scope of the present invention.

In the example of FIG. 6, upgrading (608), in dependence upon a previous scope of access permissions (610) for the requested computer resource and upon the current measure of disuse (606) by the user of the requested computer resource, the user's degraded scope of access permissions (138) to grant access to the requested computer resource is carried out in dependence upon permission upgrade rules (616). Permission upgrade rules (616) are processing guidelines for upgrading permissions in dependence upon varying degrees of disuse and a user's permission history (610). For further explanation, two exemplary permission upgrade rules are set forth below:
RULE 1:
If a temporal measure of a user's disuse of a resource is greater than one week
AND
the user's degraded scope of access permission excludes delete permission for the resource
AND
the user's previous scope of access permission included delete permission for the resource
THEN
upgrade the user's degraded scope of access permission to include delete permission for that resource.
RULE 2:
If a temporal measure of a user's disuse of a resource is greater than one month
AND
the user's degraded scope of access permission excludes write permission for that resource
AND
the user's previous scope of access permission included write permission for the resource
THEN
upgrade the user's degraded scope of access permission to include write permission for that resource.

The fact that two rules are used to exemplify permission upgrade rules is not a limitation of the present invention. The use of any number of permission upgrade rules is well within the scope of the present invention. These exemplary upgrade rules illustrate that systems according to embodiments of the present invention may gracefully upgrade a user's scope of access permissions in a security domain transparently to the user. Upgrading (608) access permissions in dependence upon a user's previous scope of access permissions (610) and upon the user's current measure of disuse (606) may be carried out securely by, for example, asynchronously notifying a system administrator or other user that the user's scope of permissions was upgraded. That is, in such a system, for a user who is qualified for an upgrade according to current disuse, previous permissions, and a system's permission upgrade rules, the user's permissions may be automatically upgraded transparently with no blocking calls to notify a system administrator or ask for immediate on-line approval.

In support of additional security controls, a system administrator or other user may be notified asynchronously that the user's degraded scope of permission was upgraded. Systems that utilize permission histories (610) also advantageously track permissions changes, both degradations and upgrades, by creating permissions history records when permissions changes occur. Asynchronous notifications to system administrators in such systems may take the form of, or may be derived from, the pertinent permissions history records because in systems that use them, the permissions history records record the upgrades.

### Collapsing Individual ACEs into a Group ACE

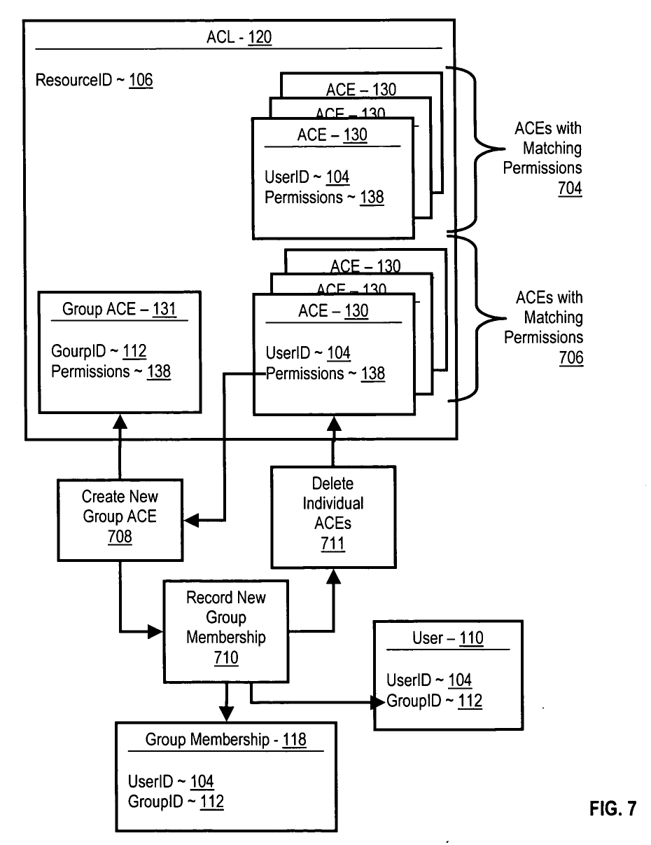

For further explanation, FIG. 7 sets forth a flow chart illustrating a further exemplary method of changing access permission based on usage of computer resources that effectively collapses a number of individual ACEs into a smaller number of group ACEs. More particularly, in the method of FIG. 7, at least one computer resource, identified by resourceID (106), has access permissions (138) for users. In the example of FIG. 7, each access permission for a user is expressed in an ACE (130) in an ACL (120) for the at least one computer resource. In addition, in the example of FIG. 7, individual ACEs in the ACL identify one or more sets of users having matching access permissions (704, 706). In the particular example of FIG. 7, only two sets of users having matching access permissions (704, 706) are illustrated, although this is not a limitation of the present invention. On the contrary, systems according to the present invention support any number of sets of users having matching access permissions.

The method of FIG. 7 includes creating (708) a new group ACE (131) for each set of users having matching access permissions, recording (710) for each user in each set of users having matching access permissions a new group membership, and deleting (711) from the ACL the individual ACEs (704, 706) that identify one more sets of users having matching access permissions. The method of FIG. 7 includes two alternative methods of recording (710) a new group membership for each user in each set of users having matching access permissions: recording a new group membership in a user account record (110), useful in systems that do not support multiple group memberships, and recording a new group membership by creating a new group membership record (118), useful in systems that do support multiple group memberships.

Persons of skill in the art will recognize among the benefits of using various embodiments of the present invention the following: Access history logs according to embodiments of the present invention may be used to support automated tools to reinstate individual user access rights or group rights upon request. Application of automated methods of changing access permission based on usage may be limited to system accounts which may tend to be more regular and require fewer resources than user accounts representing human users. Access history logs according to embodiments of the present invention may be used to support profiling tools that aid system administrators in design default permissions profiles for users. Access history logs according to embodiments of the present invention may be used to support graphical tools that aid administrators in controlling access rights. Access history logs according to embodiments of the present invention may be used to support informational tools to advise users which access rights have recently been lost to disuse. Systems and methods according to embodiments of the present invention may be used to support configuration options that override automated rights reductions by explicitly stating that a particular user retains rights to certain resources regardless of patterns of usage.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of changing access permission based on usage of computer resources, the method comprising:
maintaining records of a user's usage of computer resources in a security domain, the user having a scope of access permission for the computer resources;
measuring the user's disuse of one or more of the computer resources in the security domain; and
degrading the user's scope of access permission for the computer resources in dependence upon the user's disuse.

2. The method of claim 1 wherein:
measuring the user's disuse of one or more of the computer resources in the security domain further comprises identifying, among permissions for the user, a disused access permission for at least one of the computer resources; and
degrading the user's scope of access permission for the computer resources in dependence upon the user's disuse further comprises removing the disused permission from the permissions for the user.

3. The method of claim 1 further comprising:
receiving from a user a request for access to a requested computer resource, the user having a degraded scope of access permissions that exclude access to the requested computer resource;
denying access to the requested computer resource in dependence upon the user's degraded scope of access permissions that exclude access to the requested computer resource;
receiving from the user a request to upgrade the user's degraded scope of access permissions to grant access to the requested computer resource; and
upgrading, in dependence upon the user's request to upgrade the degraded scope of access permissions, the user's degraded scope of access permissions to grant access to the requested computer resource.

4. The method of claim 1 further comprising:
receiving from the user a request for access to a requested computer resource, the user having a degraded scope of access permissions that exclude access to the requested computer resource; and
measuring the user's current disuse of the requested computer resource; and
upgrading, in dependence upon a previous scope of access permissions for the requested computer resource and upon the current measure of disuse by the user of the requested computer resource, the user's degraded scope of access permissions to grant access to the requested computer resource.

5. The method of claim 1 wherein at least one computer resource has access permissions for a multiplicity of users wherein each access permission for a user is expressed in an ACE in an ACL for the at least one computer resource, wherein a plurality of individual ACEs in the ACL identify one or more sets of users having matching access permissions, the method further comprising:
creating a new group ACE for each set of users having matching access permissions;
recording for each user in each set of users having matching access permissions a new group membership; and
deleting from the ACL the individual ACEs that identify one more sets of users having matching access permissions.

6. The method of claim 1 wherein maintaining records of a user's usage of computer resources further comprises creating a user access history for each computer resource, wherein the user access history includes a user identification, a computer resource identification, and a timestamp identifying the date and time of a user's accessing a computer resource associated with the user access history.

7. The method of claim 1 wherein measuring disuse of the one or more computer resources further comprises comparing a timestamp in a user access history with a predetermined threshold.

8. The method of claim 1 wherein degrading the user's scope of access permission for the computer resources in dependence upon the disuse further comprises degrading the user's scope of access permission for the computer resources according to permission degradation rules.

9. The method of claim 1 further comprising generating a disuse profile, wherein degrading the user's scope of access permission for the computer resources in dependence upon the disuse further comprises an authorized user's degrading the user's scope of access permission for the computer resources in dependence upon the disuse profile.

10. A system for changing access permission based on usage of computer resources, the system comprising:
means for maintaining records of a user's usage of computer resources in a security domain, the user having a scope of access permission for the computer resources;
means for measuring the user's disuse of one or more of the computer resources in the security domain; and
means for degrading the user's scope of access permission for the computer resources in dependence upon the user's disuse.

11. The system of claim 10 wherein:
means for measuring the user's disuse of one or more of the computer resources in the security domain further comprises means for identifying, among permissions for the user, a disused access permission for at least one of the computer resources; and
means for degrading the user's scope of access permission for the computer resources in dependence upon the user's disuse further comprises means for removing the disused permission from the permissions for the user.

12. The system of claim 10 further comprising:
means for receiving from a user a request for access to a requested computer resource, the user having a degraded scope of access permissions that exclude access to the requested computer resource;
means for denying access to the requested computer resource in dependence upon the user's degraded scope of access permissions that exclude access to the requested computer resource;
means for receiving from the user a request to upgrade the user's degraded scope of access permissions to grant access to the requested computer resource; and
means for upgrading, in dependence upon the user's request to upgrade the degraded scope of access permissions, the user's degraded scope of access permissions to grant access to the requested computer resource.

13. The system of claim 10 further comprising:
means for receiving from the user a request for access to a requested computer resource, the user having a degraded scope of access permissions that exclude access to the requested computer resource; and
means for measuring the user's current disuse of the requested computer resource; and
means for upgrading, in dependence upon a previous scope of access permissions for the requested computer resource and upon the current measure of disuse by the user of the requested computer resource, the user's degraded scope of access permissions to grant access to the requested computer resource.

14. The system of claim 10 wherein at least one computer resource has access permissions for a multiplicity of users wherein each access permission for a user is expressed in an ACE in an ACL for the at least one computer resource, wherein a plurality of individual ACEs in the ACL identify one or more sets of users having matching access permissions, the system further comprising:
means for creating a new group ACE for each set of users having matching access permissions;
means for recording for each user in each set of users having matching access permissions a new group membership; and
means for deleting from the ACL the individual ACEs that identify one more sets of users having matching access permissions.

15. The system of claim 10 wherein means for maintaining records of a user's usage of computer resources further comprises means for creating a user access history for each computer resource, wherein the user access history includes a user identification, a computer resource identification, and a timestamp that identifies the date and time of a user's accessing a computer resource associated with the user access history.

16. The system of claim 10 wherein means for measuring disuse of the one or more computer resources further comprises means for comparing a timestamp in a user access history with a predetermined threshold.

17. The system of claim 10 wherein means for degrading the user's scope of access permission for the computer resources in dependence upon the disuse further comprises means for degrading the user's scope of access permission for the computer resources according to permission degradation rules.

18. The system of claim 10 further comprising means for generating a disuse profile, wherein means for degrading the user's scope of access permission for the computer resources in dependence upon the disuse further comprises means for an authorized user's degrading the user's scope of access permission for the computer resources in dependence upon the disuse profile.

19. A computer program product of changing access permission based on usage of computer resources, the computer program product comprising:
a recording medium;
means, recorded on the recording medium, for maintaining records of a user's usage of computer resources in a security domain, the user having a scope of access permission for the computer resources;
means, recorded on the recording medium, for measuring the user's disuse of one or more of the computer resources in the security domain; and
means, recorded on the recording medium, for degrading the user's scope of access permission for the computer resources in dependence upon the user's disuse.

20. The computer program product of claim 19 wherein:
means for measuring the user's disuse of one or more of the computer resources in the security domain further comprises means, recorded on the recording medium, for identifying, among permissions for the user, a disused access permission for at least one of the computer resources; and
means for degrading the user's scope of access permission for the computer resources in dependence upon the user's disuse further comprises means, recorded on the recording medium, for removing the disused permission from the permissions for the user.

21. The computer program product of claim 19 further comprising:
means, recorded on the recording medium, for receiving from a user a request for access to a requested computer resource, the user having a degraded scope of access permissions that exclude access to the requested computer resource;
means, recorded on the recording medium, for denying access to the requested computer resource in dependence upon the user's degraded scope of access permissions that exclude access to the requested computer resource;
means, recorded on the recording medium, for receiving from the user a request to upgrade the user's degraded scope of access permissions to grant access to the requested computer resource; and
means, recorded on the recording medium, for upgrading, in dependence upon the user's request to upgrade the degraded scope of access permissions, the user's degraded scope of access permissions to grant access to the requested computer resource.

22. The computer program product of claim 19 further comprising:
means, recorded on the recording medium, for receiving from the user a request for access to a requested computer resource, the user having a degraded scope of access permissions that exclude access to the requested computer resource; and
means, recorded on the recording medium, for measuring the user's current disuse of the requested computer resource; and
means, recorded on the recording medium, for upgrading, in dependence upon a previous scope of access permissions for the requested computer resource and upon the current measure of disuse by the user of the requested computer resource, the user's degraded scope of access permissions to grant access to the requested computer resource.

23. The computer program product of claim 19 wherein at least one computer resource has access permissions for a multiplicity of users wherein each access permission for a user is expressed in an ACE in an ACL for the at least one computer resource, wherein a plurality of individual ACEs in the ACL identify one or more sets of users having matching access permissions, the computer program product further comprising:
means, recorded on the recording medium, for creating a new group ACE for each set of users having matching access permissions;
means, recorded on the recording medium, for recording for each user in each set of users having matching access permissions a new group membership; and
means, recorded on the recording medium, for deleting from the ACL the individual ACEs that identify one more sets of users having matching access permissions.

24. The computer program product of claim 19 wherein means, recorded on the recording medium, for maintaining records of a user's usage of computer resources further comprises means, recorded on the recording medium, for creating a user access history for each computer resource, wherein the user access history includes a user identification, a computer resource identification, and a timestamp identifying the date and time of a user's accessing a computer resource associated with the user access history.

25. The computer program product of claim 19 wherein means, recorded on the recording medium, for measuring disuse of the one or more computer resources further comprises means, recorded on the recording medium, for comparing a timestamp in a user access history with a predetermined threshold.

26. The computer program product of claim 19 wherein means, recorded on the recording medium, for degrading the user's scope of access permission for the computer resources in dependence upon the disuse further comprises means, recorded on the recording medium, for degrading the user's scope of access permission for the computer resources according to permission degradation rules.

27. The computer program product of claim 19 further comprising means, recorded on the recording medium, for generating a disuse profile, wherein means, recorded on the recording medium, for degrading the user's scope of access permission for the computer resources in dependence upon the disuse further comprises means, recorded on the recording medium, for an authorized user's degrading the user's scope of access permission for the computer resources in dependence upon the disuse profile.
